(19) United States
(12) Patent Application Publication
(10) Pub. No.: US 2012/0248963 A1
(43) Pub. Date: Oct. 4, 2012

(54) ELECTRICAL HIGH-PRESSURE DISCHARGE LAMP FOR COSMETIC SKIN TREATMENT

(75) Inventor: Ulrich Berger, Biebergemuend-Breitenborn (DE)

(73) Assignee: HERAEUS NOBLELIGHT GMBH, Hanau (DE)

(21) Appl. No.: 13/513,616

(22) PCT Filed: Dec. 2, 2010
(86) PCT No.: PCT/EP10/07319

§ 371 Date: Jun. 4, 2012

(30) Foreign Application Priority Data
Dec. 4, 2009 (DE) 10 2009 056 753.4

(51) Int. Cl. H01J 61/40

(52) U.S. Cl. 313/112

(57) ABSTRACT

An electrical high-pressure discharge lamp is provided for a cosmetic skin treatment. The lamp includes an illuminating tube made of quartz glass. At least two electrodes made of metal are arranged in the illuminating tube at a spacing from each other that is larger than the internal diameter of the illuminating tube. A gas is enclosed in the illuminating tube, and the quartz glass is doped with copper and tin, which reduces the transmission by the illuminating tube for electromagnetic radiation of a wavelength shorter than 550 nm. A use of an electrical high-pressure discharge lamp of this type in a tanning device or lamp for cosmetic skin treatment is also provided.

### CROSS-REFERENCE TO RELATED APPLICATIONS

This application is a Section 371 of International Application No. PCT/EP2010/007319, filed Dec. 2, 2010, which was published in the German language on Jun. 9, 2011, under International Publication No. WO 2011/066967 A1, and the disclosure of which is incorporated herein by reference.

### BACKGROUND OF THE INVENTION

The invention relates to an electrical high-pressure discharge lamp for a cosmetic skin treatment, comprising an illuminating tube made of quartz glass, wherein at least two electrodes made of metal are arranged in the illuminating tube at a spacing from each other that is larger than the internal diameter of the illuminating tube. Moreover, the invention relates to the use of an electrical high-pressure discharge lamp according to the invention.

A number of investigations has shown that irradiation of human skin with light in the wavelength range between 530 and 950 nm leads to a reduction of wrinkles and thus to rejuvenation of the skin. This is mainly being attributed to the light in the wavelength range triggering the collagen production of the skin. This leads to the skin becoming more taut. It is known according to the prior art to use red LEDs for methods of this type. Lamps are constructed based on the red LEDs, which are then used for irradiation of skin areas. It has proven to be disadvantageous that LEDs only comprise line spectra which have a bandwidth of often less than 15 nm. Depending on the specific skin type, this may regrettably not result in the desired effect.

Electrical high-pressure discharge lamps, for example, are examples of irradiation lamps emitting a nearly continuous spectrum. The electrical high-pressure discharge lamps for cosmetic skin treatments are known, for example, from U.S. patent application publication no. 2008 255 547 A1. In order to absorb the undesired wavelengths at least partly, the high-pressure discharge lamps are arranged behind filter discs. Arrangements of this type are disadvantageous in that an additional component is required to set-up an irradiation lamp. The additional component needs space and causes additional costs.

The generic German published patent application DE 10 2006 058 279 A1 therefore proposes an illuminating tube of an electrical high-pressure discharge lamp to consist of quartz glass doped with vanadium and, optionally, with cerium and/or titanium in addition. The doping allows a filter disc to be dispensed with, since the doping reduces the radiation in the undesired range. A disadvantage here is that the absorption edges of the vanadium doping are not optimal for attaining the desired wavelength profile.

### BRIEF SUMMARY OF THE INVENTION

It is therefore the object of the invention to overcome the disadvantages of the prior art, in particular to provide an electrical high-pressure discharge lamp that generates the desired wavelength spectrum or emits a wavelength spectrum that comes as close as possible to the desired wavelength spectrum. At least the particularly unfavorable short wavelengths below 550 nm are to be avoided.

An electrical high-pressure discharge lamp for a cosmetic skin treatment is proposed to meet the object, the lamp comprising an illuminating tube made of quartz glass, wherein at least two electrodes made of metal are arranged in the illuminating tube at a spacing from each other that is larger than the internal diameter of the illuminating tube, and wherein a gas is enclosed in the illuminating tube and the quartz glass is doped with copper and tin, which reduces the transmission of the illuminating tube for electromagnetic radiation of a wavelength shorter than 550 nm.

Moreover, a use of the electrical high-pressure discharge lamp according to the invention in a tanning device or lamp for cosmetic skin treatment is proposed to meet the object. Features and details that are described in the context of the electrical high-pressure discharge lamp shall also apply with respect to the use, and vice versa.

The object is met by a gas being enclosed in the illuminating tube and the quartz glass being doped with copper and tin, which reduces the transmission of the illuminating tube for electromagnetic radiation of a wavelength shorter than 550 nm.

In this context, the invention can provide the illuminating tube to comprise quartz glass having at least 99.5% by weight SiO₂.

The invention can also provide the electrical high-pressure discharge lamp to be a halogen lamp.

An advantageous embodiment of the invention provides the gas in the illuminating tube to comprise mercury and/or lithium iodide.

The invention can also provide the illuminating tube to contain one or more halogen compound(s) of one or more metal(s) of groups I, II and/or III of the Periodic System of the elements.

The invention proposes the gas to comprise mercury iodide and lithium iodide as well as argon, and the gas to preferably comprise thallium iodide in addition.

For absorption of undesired long wavelengths, the invention proposes to provide a metal oxide coating attenuating electromagnetic radiation with a wavelength longer than 800 nm, at least on parts of the surface of the illuminating tube.

The invention can just as well provide the illuminating tube, at least on one end, with a coating that reflects thermal radiation, in particular a coating comprising zirconium oxide.

Particularly advantageous embodiments of the invention provide the doping to reduce the transmission of electromagnetic radiation having a wavelength shorter than 550 nm by 70%, preferably by 80%, as compared to a non-doped illuminating tube.

The invention can also provide the doping to reduce the transmission of electromagnetic radiation having a wavelength between 300 nm and 550 nm by 70%, preferably by 80%, as compared to a non-doped illuminating tube.

Moreover, it is particularly advantageous for the illuminating tube to transmit at least 70% of electromagnetic radiation having a wavelength between 550 nm and 750 nm.

The invention also proposes the illuminating tube to be doped with titanium.

The invention further proposes the illuminating tube to be elongated, preferably to be cylindrical, particularly preferably to be cylindrical with a circular footprint.

In order to meet the object, the invention further proposes a gas to be enclosed in the illuminating tube, wherein the gas comprises mercury and lithium iodide, the illuminating tube is additionally doped with copper and titanium, in order to reduce a transmission of the illuminating tube for electromagnetic radiation having a wavelength shorter than 550 nm.

One of the cornerstones of the invention is to be seen in the use of an electrical high-pressure discharge lamp. The high-pressure discharge lamp designed according to the invention has a comparatively continuous spectrum and thus effects collagen production and/or skin rejuvenation even in different skin types, as compared to a lamp made of LEDs. In order to attain this goal and/or meet the object posed above, the high-pressure discharge lamp according to the invention comprises an illuminating gas—also referred to as gas according to the scope of the present invention—which comprises lithium iodide. The use of lithium iodide in combination with mercury and/or a mercury compound attains an emission spectrum that is situated predominantly in the range between 530 and 950 nm. Line spectra are excited as well, but the very strong broadening of the emission spectrum results in a nearly continuous spectrum of high intensity. In addition, the electrical high-pressure discharge lamp according to the invention is characterized by the illuminating tube made of SiO₂—also referred to as quartz glass—being doped with copper and tin. The copper doping attenuates the electromagnetic radiation having a wavelength shorter than 550 nm emitted by the gas. Doping the illuminating tube causes the illuminating tube to act like a low-pass filter in the frequency range and/or like a high-pass filter in the wavelength range of the electromagnetic radiation. The doping does not attain a step function in the transmission, but the doping enables a significant portion—at least 50%—of possibly harmful UV (ultraviolet) portions in the light of the electrical high-pressure discharge lamp to be filtered out. In summary, a nearly continuous spectrum is attained in the desired wavelength range between 550 and 800 nm by the high-pressure discharge lamp according to the invention, such that a cosmetic skin treatment can be provided even for different skin types.

The invention is based on the surprising finding that combining copper and tin as doping allows the desired absorption of the lower wavelength range to be attained in a sustained manner, i.e. without the absorption properties of the illuminating tube deteriorating rapidly over time. If copper alone is used, the copper diffuses through the crystal lattice of the quartz glass and forms clusters. This is due to the high temperature to which the illuminating tube is exposed in the electrical high-pressure discharge lamp. Since the copper clusters do not re-dissolve, the amount of copper that is distributed throughout the quartz glass decreases steadily. Accordingly, the density of the copper doping decreases too quickly during the operating time. As a result, the absorption properties of the doped SiO₂ deteriorate. With increasing service time, an illuminating tube doped with copper alone therefore increasingly allows undesired, harmful, short-wave electromagnetic radiation to pass through. Surprisingly, it was found that doping with tin in addition to copper inhibits or even prevents the formation of clusters at high temperatures and that this effect can be used to advantage in illuminating tubes of electrical high-pressure discharge lamps. The desired absorption properties of the illuminating tube thus are maintained over long period of time, and the electrical high-pressure discharge lamp according to the invention has a long service life. Since a copper-tin alloy is referred to as bronze, one may also speak of bronze doping of the quartz glass.

Doping with tin thus addresses the issue of the service life of an illuminating tube made of copper-doped quartz glass being very short, or of the absorption properties of a copper-doped illuminating tube made of SiO₂ deteriorating over time. This is due to the high temperature of the electrical high-pressure discharge lamp in operation. This meets the object, being to provide an electrical high-pressure discharge lamp which not only emits the advantageous spectrum, but also does not deteriorate when in operation, i.e. does not experience undesirable ageing. The advantage is to be seen in that the high-pressure discharge lamp and/or the illuminating tube does not need to be replaced regularly in order to prevent any hazard to the radiated individual. This saves costs, resources, and time and renders all devices equipped with the high-pressure discharge lamp according to the invention more user-friendly.

In the scope of the invention, collagen shall be understood to mean a structural protein of connective tissue (more exactly: of the extracellular matrix) that is present in humans and animals. Its fraction of 30% of the total weight of all proteins in the human body makes collagen the most common protein. Collagen is an essential organic component of bones and skin.

In the scope of the invention, doping shall be understood to mean a process in which the SiO₂ material of the illuminating tube is purposefully contaminated with foreign atoms. In this context, the foreign atoms are introduced into the crystalline atomic structure by ion bombardment or diffusion, etc. There are a variety of doping procedures, for example diffusion, sublimation from the gas phase or bombardment by high energy particle guns in a vacuum (ion implantation). However, the copper and the tin can also be added to a melted SiO₂ material in elemental form, as bronze or, better, as oxides in order to produce a quartz glass with the desired doping.

In the scope of the invention, high-pressure discharge lamps or gas discharge lamps shall be understood to mean light sources that use a gas discharge to generate light and utilize the spontaneous emission through atomic or molecular electronic transitions and the recombination radiation of a plasma generated by electrical discharge for this purpose. According to the invention, the gas generating the plasma is a mixture that contains mercury and lithium iodide, wherein noble gases (xenon, krypton, neon) may be contained therein as well. The two electrodes in the illuminating tube can comprise tungsten (solid or wire wrap). The current density inside the illuminating tube is sufficiently high for the low pressure discharge at the start to immediately transition into an arc discharge, such that the internal pressure increases strongly due to the increasing temperature and evaporating ingredients filling the tube. Depending on design, the electrodes reach temperatures of approximately 1,000° C. up to several thousand ° C. and are not preheated. Due to the higher density and the resulting smaller free path of the particles, electron and gas temperature are approximately in balance in the high-pressure discharge lamp (p>0.1 bar or >10,000 Pa). In contrast to tube lights, the voltages are low (50 to 200 V) and the discharge currents are markedly higher (typically 1 to 10 A).

Transmission is a value that describes the permeability of a medium for electromagnetic waves. If a wave propagating in medium A hits a medium B of finite thickness, it is partially reflected at the boundary surfaces, depending on the substance properties of the barrier, and absorbed fully or partially during its transit. The remainder is transmitted through medium B and exits from medium B on the opposite side thereof. The transmission—also referred to as degree of transmission—is a measure of the intensity “allowed to pass through”.

An advantageous embodiment of the high-pressure discharge lamp according to the invention is characterized by the illuminating tube containing one or more halogen compound(s) of one or more metal(s) of groups I, II and/or III of the Periodic System of the elements. Lithium compounds are only used to a limited degree in high-pressure discharge lamps, since they are known to show a certain aggressiveness that varies as a function of concentration. According to the invention, the lithium concentration can be sufficiently low, such that no or only little damage to the illuminating tube made of quartz glass is expected over the expected service life. However, if the radiation of the gas in the wavelength range mentioned above is needed to be very high, a halogen and/or a halogen compound can be added to the gas of the illuminating tube in order to attenuate the aggressive effect of the lithium iodide. The halogen compounds dissociate in the plasma, but the temperature in the vicinity of the wall of the illuminating tube is sufficiently low that it presumably is exposed just to the halogen salts and thus may be shielded from possible harmful lithium vapors. This type of shielding of the internal wall of the illuminating tube also allows high concentrations of lithium iodide in the gas to be utilized, which provide for correspondingly high illumination intensities of the high-pressure discharge lamp.

Another advantageous embodiment is characterized by the gas comprising mercury iodide and lithium iodide, as well as argon. In this context, the purpose the noble gas argon serves is to stabilize the discharge. Accordingly, a particularly homogeneous and long-term usable spectrum is generated, which is similar to a continuous emitter and has proven to be particularly efficient and effective for cosmetic skin treatments. It has also proven to be advantageous to introduce a non-aggressive metal, such as thallium or thallium iodide, into the gas, aside from the halogen compounds mentioned above. Thallium iodide, in particular, has proven to be advantageous since the iodine deposits at the cooler walls of the illuminating tube, where it forms compounds with the vaporized tungsten. Accordingly, the volatile compound disintegrates at very high temperatures, i.e. especially at the electrodes. As a result, the decrease in light intensity caused by the blackening of the vessel wall is reduced.

It has proven to be advantageous to provide the illuminating tube with a metal oxide coating in order to attenuate the electromagnetic radiation of a wavelength longer than 800 nm. Combining the electrical high-pressure discharge lamp, which is provided according to the invention, and a metal oxide coating results in band-pass behavior. Doping the illuminating tube with copper and tin, and optionally with titanium also, reduces the emission of UV radiation from the high-pressure discharge lamp. The IR (infrared) portion of the emitted light can be reduced by coating the illuminating tube with at least one metal oxide. This also does not result in an attenuation that corresponds to the profile of a step function. But coating with a metal oxide allows a reduction of the transmission from a wavelength of 850 nm by at least 50%, as compared to an uncoated illuminating tube to be attained. The use of titanium oxide as metal oxide has proven to be particularly advantageous, since titanium oxide attains at least 50% attenuation of the electromagnetic radiation in a wavelength range between 800 nm and 1,200 nm. The metal oxide coating provided according to the invention can be produced by a dip coating procedure. The metal-alcoholic coating solutions used in the procedure are converted into firmly adhering metal oxide layers in a thermal process.

Another advantageous embodiment of the electrical high-pressure discharge lamp according to the invention is characterized by the illuminating tube being provided, at least on one end, with a coating reflecting the thermal radiation. Generating a plasma in the high-pressure discharge lamp produces a substantial fraction of thermal radiation. In order not to damage the electrodes that are situated on the respective external ends of the elongated illuminating tube, it has proven to be advantageous to provide the ends with a coating that reflects the thermal radiation. Particularly high reflectivity for thermal radiation, which contains the mercury and lithium iodide in a gas, results from the use of zirconium oxide. Zirconium oxide can be applied simply and easily to the outside of the illuminating tube and forms a lasting and durable coating that guides the thermal radiation away from the electrodes by reflection.

As described above, a high-pressure discharge lamp according to the invention is characterized by three particularities:
1. The gas contains mercury and lithium iodide in order to thus attain an emission spectrum in the wavelength range between 550 and 800 nm;
2. In addition, the illuminating tube comprising quartz glass is doped with copper, and also optionally with titanium, in order to thus reduce a transmission of the illuminating tube for any electromagnetic radiation having a wavelength shorter 550 nm; and
3. The illuminating tube is also doped with tin, in order to prevent the copper from clustering and thus ensure the stability of the absorption properties.

Another advantageous embodiment provides the doping to reduce the illuminating tube's transmission of electromagnetic radiation having a wavelength shorter than 550 nm by 70%, in particular by 80%, as compared to a non-doped illuminating tube. The desired reduction of the transmission by the specified percentage ensures that UV radiation does not damage the skin of the person being irradiated with the high-pressure discharge lamp according to the invention. It has also proven to be particularly advantageous if the doping reduces the transmission of electromagnetic radiation having a wavelength between 300 nm and 550 nm by 70%, in particular by 80%, as compared to a non-doped illuminating tube. In the latter wavelength range, there still is some non-negligible emission of electromagnetic radiation by the gas of the high-pressure discharge lamp according to the invention. The portion of the wavelength spectrum can be reduced significantly by doping the SiO₂ of the illuminating tube with copper, and optionally also with titanium, in order to prevent possible skin damage.

Another advantageous embodiment of the electrical high-pressure discharge lamp is characterized by the illuminating tube transmitting at least 70% of the electromagnetic radiation having a wavelength between 550 nm and 750 nm. Making up the elongated illuminating tube so as to be very pure—aside from the doping—from at least 99.5% by weight SiO₂, preferably 99.75% by weight SiO₂, results in just slight attenuation of the electromagnetic radiation during its transit through the illuminating tube. Thus, a satisfactory transmission of at least 70% is achieved for electromagnetic radiation in the wavelength range of interest between 550 nm and 750 nm.

A use of an electrical high-pressure discharge lamp according to the invention in a tanning device or emitter for a cosmetic skin treatment is also claimed according to the invention. The use of the high-pressure discharge lamp according to the invention in a tanning device serves to induce the collagen production in the skin of an irradiated body part. The particularity according to the invention is that the high-pressure discharge lamp disclosed herein can be integrated directly into common commercial tanning devices—also referred to as sun-tanning devices. Thus, tanning devices used for commercial purposes—also referred to as sun beds—can be converted by exchanging the integrated high-pressure discharge lamp for the one disclosed herein in treatment devices for the skin. Unlike the LEDs known from the prior art, there is no need for any installation of new elements, connections and/or brackets for integration of the sources of electromagnetic radiation. According to the invention, it is sufficient to simply integrate the high-pressure discharge lamp disclosed herein in addition or alone in pre-existing tanning devices.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic longitudinal view of a first embodiment of an electrical high-pressure discharge lamp according to the invention;

FIG. 2 is a schematic longitudinal view of another embodiment of the electrical high-pressure discharge lamp according to the invention; and

FIG. 3 is a magnified detail of region III from FIG. 2.

### DETAILED DESCRIPTION OF THE INVENTION

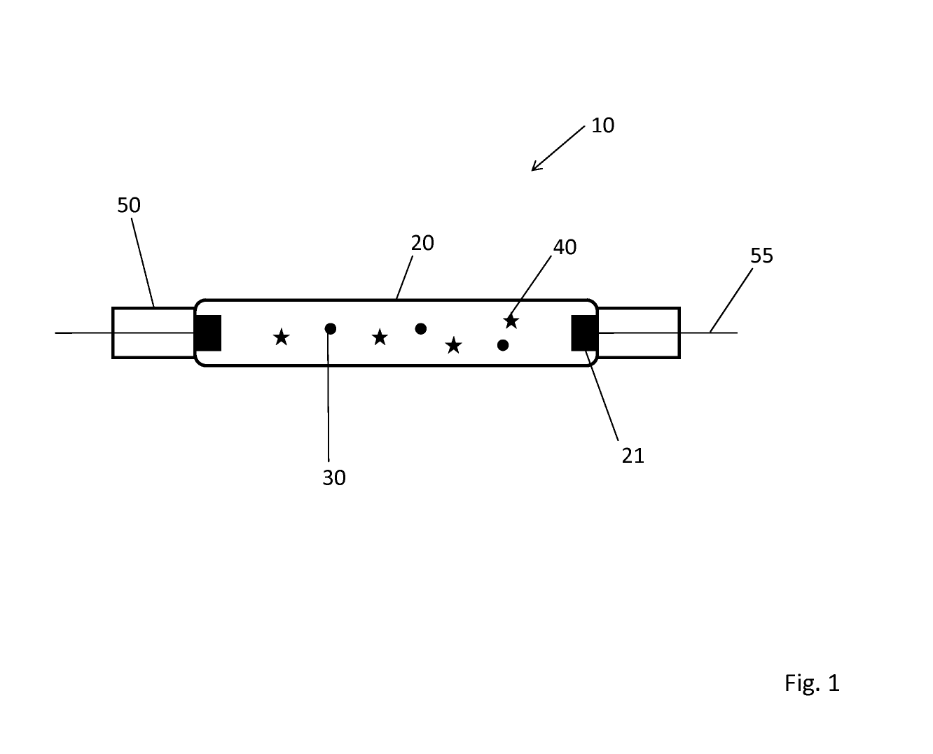

FIG. 1 shows an electrical high-pressure discharge lamp 10 according to the invention. The high-pressure discharge lamp 10 comprises an elongated illuminating tube 20 made of a low hydrogen quartz in order to reduce the loss of light. For this purpose, the elongated illuminating tube 20 comprises at least 99.5% by weight SiO₂. At the respective ends are situated crimpings 50 that close the illuminating tube 20 in a gas-tight manner. Lead wires 55 extend through the crimpings 50 and can be used to supply electrical energy to the electrodes 21. The mutual spacing of the electrodes 21 to each other is large as compared to an internal diameter of the illuminating tube 20. The electrodes 21 are produced from activated materials that are difficult to melt, as for example tungsten. The electrodes 21 were activated with emission materials, as for example alkaline earth carbonates and/or thorium oxide. The invention provides the high-pressure discharge lamp 10 to be used for cosmetic skin treatments, and it should therefore emit electromagnetic radiation having a wavelength range between 550 nm and 800 nm. To attain this goal, the illuminating tube 20 is filled with a gas that comprises mercury 30 and lithium iodide 40. The use of lithium iodide 40 ensures that the resulting spectrum is broadened, has the desired wavelength range, and has nearly the characteristics of a continuous spectrum. The illuminating tube 20 according to the invention is further characterized by being doped with copper and tin or copper, tin, and titanium, in order to reduce a transmission by the illuminating tube 20 of electromagnetic radiation having a wavelength shorter than 550 nm. The doping ensures that the light emitted by the high-pressure discharge lamp 10 comprises only very small portions in the UV range. Since these UV portions of the electromagnetic radiation are absorbed by the appropriately doped illuminating tube 20.

For further stabilization of the gas contained in the illuminating tube 20, the gas can comprise mercury iodide and lithium iodide, as well as argon. In this context, argon, being a noble gas, ensures particularly stable burning of the plasma between the two electrodes 21. Moreover, it is possible for one or more halogen compounds to be contained in the illuminating tube 20. Surprisingly, the halogen compounds have been shown to reduce a potentially harmful effect of lithium at high concentrations. Accordingly, the high-pressure discharge lamp 10 according to the invention can also be used at high lithium iodide concentrations without damage to the illuminating tube 20 made up of quartz glass.

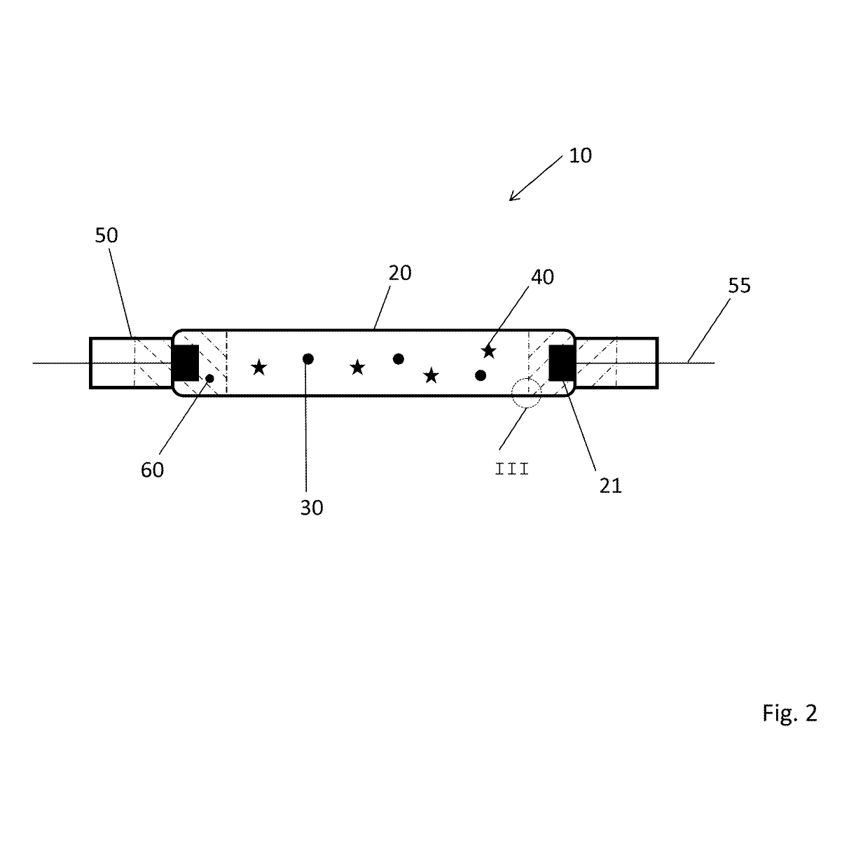

FIG. 2 shows another advantageous embodiment of the high-pressure discharge lamp 10 according to the invention. The difference as compared to the one from FIG. 1 being only that, in addition, a thermal radiation-reflecting coating 60 is provided at the ends of the illuminating tube 20. Advantageously, the reflecting coating 60 comprises zirconium oxide. Heat radiation generated by the electrodes 21 and/or the plasma of the gas are reflected into the inside 22 of the illuminating tube 20 and/or the surroundings by the reflecting coating 60.

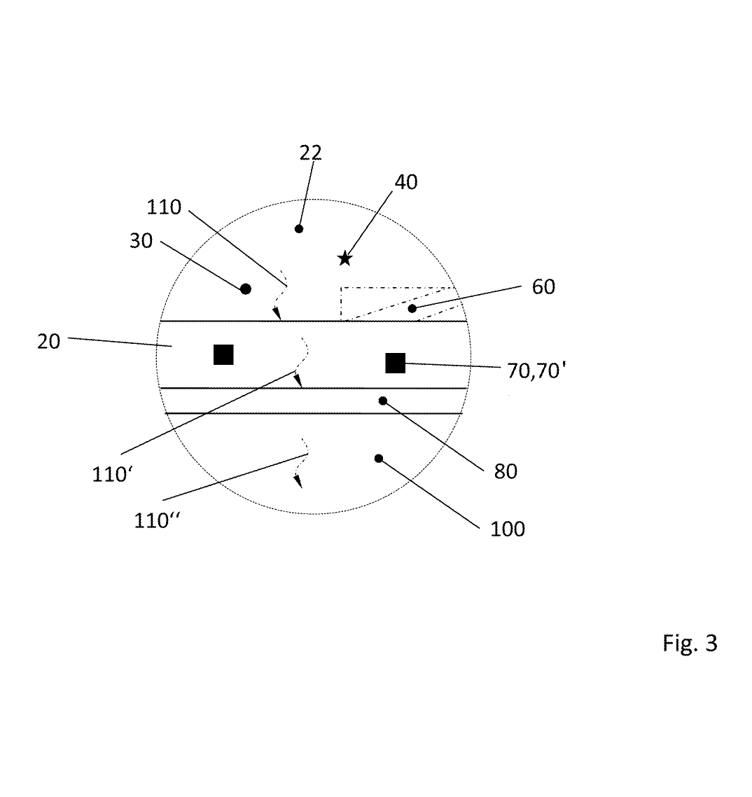

In a further embodiment, the high-pressure discharge lamp 10 can also comprise a metal oxide coating 80, which also serves for attenuation of electromagnetic radiation, which is illustrated in FIG. 3. FIG. 3 shows a magnified detail of region III from FIG. 2 and thus show a section through the internal wall of the illuminating tube 20 in the region of the electrodes 21. The SiO₂ of the illuminating tube 20 according to the invention is doped with copper 70, tin 70′ and/or titanium 70′. What this achieves is that the transmission of the illuminating tube 20 for electromagnetic radiation 110 having a wavelength shorter than 550 nm is reduced. Doping with copper 70, tin 70′ and/or titanium 70′ causes the illuminating tube 20 to absorb the electromagnetic radiation 110 having a wavelength shorter than 550 nm. According to the invention, the external surface of the illuminating tube 20 can, in addition, be provided with a metal oxide coating 80. Advantageously, the coating is made of titanium oxide. The metal oxide coating 80 attenuates electromagnetic radiation 110′ having a wavelength longer than 800 nm. The doping and the coating with a metal oxide cause the illuminating tube 20 to show the properties of a band-pass filter. Only electromagnetic radiation 110″ having a wavelength between 550 nm and 800 nm reaches the surroundings of the high-pressure discharge lamp nearly without attenuation. In this context, the invention provides at a maximum 30% of the light of the above-mentioned wavelength to be absorbed in the illuminating tube 20 or the coating 80. The remainder of the electromagnetic radiation 110″ exits into the surroundings 100 and can be used for cosmetic skin treatments.

Initially, the luminous gas 30, 40 generates an electromagnetic radiation 110 on the inside 22 of the illuminating tube 20. The electromagnetic radiation 110 enters the quartz walls of the illuminating tube 20. In this location, it is partially absorbed at the dopings 70, 70′ of the quartz glass, mainly in the wavelength range below 550 nm. Filtered in the lower wavelength range, the electromagnetic radiation 110′ then enters the metal oxide coating 80, where another partial absorption proceeds, mainly in the wavelength range above 750 nm or 800 nm. And lastly, the electromagnetic radiation 110″, which has been filtered in the upper and lower wavelength ranges, exits from the high-pressure discharge lamp into the surroundings 100.

Heat is produced during the operation of the electrical high-pressure discharge lamp 10. In the process, the illuminating tube 20 is exposed to temperatures in the range of up to 1,000° C. At these temperatures, copper 70 can diffuse within the quartz glass. In order to prevent the copper from clumping or clustering in the quartz glass, the quartz glass is additionally doped with tin 70′. The tin 70′ prevents the formation of copper clusters and thus the reduction of the density of copper 70 in the SiO₂-Matrix.

Since the doping of the quartz glass with copper 70 is essential for the desired absorption properties of the high-pressure discharge lamp 10, the formation of copper clusters and concurrent reduction of the copper concentration in the quartz glass would lead to a deterioration of the absorption properties of the illuminating tube 20. Accordingly, with increasing service time of the high-pressure discharge lamp 10, increasingly more electromagnetic radiation 110″ would be emitted in the undesired wavelength range below 550 nm. This is prevented or at least inhibited by additional doping of the quartz glass with tin 70′. Copper 70 and tin 70′ can be added or dosed for doping in nearly equal quantities.

Doping of the SiO₂ with titanium 70′ can be effected in addition, in order to attain additional absorption and to render the absorption range more homogeneous.

The features of the invention disclosed in the preceding description and in the claims, figures, and exemplary embodiments, can be essential for the implementation of the various embodiments of the invention both alone and in any combination.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-14. (canceled)

15. An electrical high-pressure discharge lamp (10) for a cosmetic skin treatment, the lamp comprising an illuminating tube (20) made of quartz glass, at least two electrodes (21) made of metal arranged in the illuminating tube at a spacing from each other that is larger than an internal diameter of the illuminating tube, and a gas enclosed in the illuminating tube, wherein the quartz glass is doped with copper and tin such that it reduces transmission of electromagnetic radiation having a wavelength shorter than 550 nm by the illuminating tube.

16. The electrical high-pressure discharge lamp (10) according to claim 15, wherein the quartz glass comprises at least 99.5% by weight SiO2.

17. The electrical high-pressure discharge lamp (10) according to claim 15, wherein the electrical high-pressure discharge lamp (10) is a halogen lamp.

18. The electrical high-pressure discharge lamp (10) according to claim 15, wherein the gas in the illuminating tube (20) comprises at least one of mercury and lithium iodide.

19. The electrical high-pressure discharge lamp (10) according to claim 15, wherein the illuminating tube (20) contains at least one halogen compound of at least one metal selected from Groups I, II and/or III of the Periodic System of the elements.

20. The electrical high-pressure discharge lamp (10) according to claim 15, wherein the gas comprises mercury iodide, lithium iodide and argon.

21. The electrical high-pressure discharge lamp (10) according to claim 20, wherein the gas further comprises thallium iodide.

22. The electrical high-pressure discharge lamp (10) according to claim 15, further comprising a metal oxide coating (80) provided at least on parts of a surface of the illuminating tube (20) to attenuate electromagnetic radiation having a wavelength longer than 800 nm.

23. The electrical high-pressure discharge lamp (10) according to claim 15, further comprising a coating (60) that reflects heat radiation, the coating being provided on at least one end the illuminating tube (20).

24. The electrical high-pressure discharge lamp (10) according to claim 23, wherein the coating (60) comprises zirconium oxide.

25. The electrical high-pressure discharge lamp (10) according to claim 15, wherein the doping reduces the transmission of electromagnetic radiation having a wavelength shorter than 550 nm by 70%, as compared to a non-doped illuminating tube.

26. The electrical high-pressure discharge lamp (10) according to claim 25, wherein the doping reduces the transmission of electromagnetic radiation having a wavelength shorter than 550 nm by 80%, as compared to a non-doped illuminating tube.

27. The electrical high-pressure discharge lamp (10) according to claim 15, wherein the doping reduces the transmission of electromagnetic radiation having a wavelength between 300 nm and 550 nm by 70%, as compared to a non-doped illuminating tube.

28. The electrical high-pressure discharge lamp (10) according to claim 27, wherein the doping reduces the transmission of electromagnetic radiation having a wavelength between 300 nm and 550 nm by 80%, as compared to a non-doped illuminating tube.

29. The electrical high-pressure discharge lamp (10) according to claim 15, wherein the illuminating tube (20) transmits at least 70% of electromagnetic radiation having a wavelength between 550 nm and 750 nm.

30. The electrical high-pressure discharge lamp (10) according to claim 15, wherein the illuminating tube (20) is further doped with titanium.

31. The electrical high-pressure discharge lamp (10) according to claim 15, wherein the illuminating tube (20) is elongated.

32. The electrical high-pressure discharge lamp (10) according to claim 31, wherein the illuminating tube (20) is cylindrical.

33. The electrical high-pressure discharge lamp (10) according to claim 31, wherein the illuminating tube (20) is cylindrical with a circular foot print.

34. A tanning device for cosmetic skin treatment comprising the electrical high-pressure discharge lamp (10) according to claim 15.
